(19) United States
(12) Patent Application Publication
(10) Pub. No.: US 2010/0247921 A1
(43) Pub. Date: Sep. 30, 2010

(54) NOVEL RESIN COMPOSITION, COMPOSITE MATERIAL CONTAINING THE SAME AND USE OF THE COMPOSITE MATERIAL

(75) Inventors: Kyoji Kitamura, Kyoto (JP); Masaki Nakamura, Kyoto (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi, Kyoto (JP)

(21) Appl. No.: 12/675,481

(22) PCT Filed: Oct. 17, 2008
(86) PCT No.: PCT/JP2008/068887

§ 371 Date: Feb. 26, 2010

(30) Foreign Application Priority Data
Nov. 5, 2007 (JP) 2007-287202

(51) Int. Cl. B32B 27/38; C08G 65/38; C08G 16/00; B32B 15/08; B32B 37/02

(52) U.S. Cl. 428/418; 528/219; 528/220; 428/457; 156/307.3

(57) ABSTRACT

Disclosed is a resin composition which can firmly bond a metal with a molding material, a composite material including the resin composition and use of the composite material. The resin composition of the present invention includes: an organic compound having at least one secondary thiol group per molecule; and a curable compound having at least one hydroxyl group per molecule.

### TECHNICAL FIELD

The present invention relates to a novel resin composition and a composite material including the novel resin composition. Particularly, the present invention relates to (i) a resin composition including an organic compound having at least one secondary thiol group per molecule and a curable compound having at least one hydroxyl group per molecule, which resin composition enhances adhesiveness of a metal and a molding material, (ii) a composite material including the resin composition and (iii) use of the composite material.

### BACKGROUND ART

In the electronic component industry, users strongly request for reduction of weight, size, and thickness of a component, so-called, a light, thin and small component. In order to satisfy such a request, reduction of the number of components and compounding of components have been essential.

A typical example for the reduction of weight, size, and thickness of an electronic component is bonding foreign materials, such as bonding a molding material (thermosetting resin or thermoplastic resin) and a metal material. In order to bond the molding material and the metal material together, the molding material and the metal material are formed individually; an adhesive is applied to the molding material and the metal material, and thereafter the two materials are cured by energy such as heat or UV ray. This technique attains a certain adhesive strength, however requires the adhesive to be thick in thickness. This thick adhesive has prevented the reduction of thickness and size of a component.

An injection molding process is a method for preparing a three-dimensional object by (i) thermally melting the molding material to improve fluidity thereof, (ii) filling the molding material into a mold and (iii) cooling the molding material to solidify the molding material. In case of producing a composite component made of a molding material and a metal by the injection molding process, compounding has been performed by placing a metal inside the mold in advance and thereafter performing insert molding.

However, because the heating or cooling only causes a change in state of the molding material between liquid and solid, i.e. a physical change of the molding material, an interface of the metal and the molding material has no affinity therebetween. Thus, it is difficult to ensure a sufficient adhesive strength. As a result, a bonded section of an electronic component peels off during use of the electronic component, and airtightness is lost in a case where the adhesive section of the electronic component has a sealing structure.

Consequently, structural measures have been taken, such as (i) attaining an anchor effect by roughening a metal surface, (ii) and opening a through-hole in the metal then covering the whole metal with the molding material. However, as a common problem, freedom in design and shape of goods are lost, and therefore the above measure is not a sufficient method for producing a light, thin and small electronic component.

With respect to these problems, for example inventions disclosed in Patent Literatures 1 and 2 are proposed as techniques for enhancing adhesive strength of the metal with the molding material. Patent Literature 1 discloses a method for producing an electric circuit component by hot stamping, on a thermoplastic resin molded object at a specific temperature, a metal foil whose surface is processed with a triazine thiol compound in advance. Furthermore, Patent Literature 2 discloses a composite made of an aluminum alloy and a resin, in which polybutylene terephtalate (PBT) or like resin is fully attached on a surface of an aluminum-alloy object by injection molding, which surface has been subjected to contact with an aqueous solution selected from ammonia or the like.

Patent Literature 1

Japanese Patent No. 3420716 B (registered on Apr. 18, 2003)

Patent Literature 2

Japanese Patent No. 3954379 B (registered on May 11, 2007)

### SUMMARY OF THE INVENTION

However, regarding the invention disclosed in Patent Literature 1, it is not possible to attain sufficient adhesive strength on an interface between the metal and the molding material by using a processing solvent described in Patent Literature 1, as shown in Comparative Example 4 later described. Moreover, in order to solve the problem, a technique such as coating can be used simultaneously. However, this causes a further problem that the technique causes (i) an increase in the number of steps required to carry out and (ii) complicated management of waste liquid treatment of used harmful substances.

In the invention disclosed in Patent Literature 2, a metal material is limited because the invention, in order to attain a specific performance, requires use of a metal material that melts easily with alkaline or acid and that can easily be made to have a fine uneven shape for attaining an anchor effect. Concretely, a usable metal material is limited to aluminum, thereby lacking versatility. Hence, a technique to substitute for these techniques have been long awaited.

The present invention is made in view of the foregoing problems, and an object of the present invention is to provide a resin composition which firmly bonds a metal to a molding material, a composite material including the resin composition, and use of the composite material.

The inventors, in view of the above problems, performed diligent study on a resin composition which enhances adhesiveness of the metal with the molding material. As a result, the inventors found that a resin composition including an organic compound that has at least one secondary thiol group per molecule and a curable compound that has at least one hydroxyl group per molecule is suitably used. This completed the present invention.

Namely, the resin composition of the present invention includes: an organic compound having at least one secondary thiol group per molecule; and a curable compound having at least one hydroxyl group per molecule.

With this structure, the organic compound having at least one secondary thiol group per molecule has a high affinity for the molding material, and the curable compound having at least one hydroxyl group per molecule has adhesiveness with the metal. Thus, an affinity between the metal and the molding material is remarkably improved. Therefore, adhesive strength between any metal and any molding material can be attained sufficiently.

Thiol is a compound in which an oxygen atom of a hydroxyl group is replaced with a sulfur atom, and is a compound having a general formula RSH. This compound may also be called a mercaptan. In a case where thiol is seen as a substituent, thiol is called a thiol group, a hydrosulfide group, a mercapto group, a sulfhydryl group or the like. In the present specification, a compound in which a thiol group is located in a carbon at an end of an organic compound is called a primary thiol, and a compound in which a thiol group is located in a carbon second to the end of the organic compound is called a secondary thiol.

Furthermore, a thiol group located in a carbon at the end of the organic compound is called a primary thiol group and a thiol group located in a carbon second to the end of the organic compound is called a secondary thiol group.

In the resin composition of the present invention, the organic compound preferably has two or more secondary thiol groups per molecule.

As the number of the secondary thiol groups increases, the affinity between the compound having the secondary thiol group and the molding material is enhanced. Furthermore, a cross-linking structure is made between the secondary thiol group and the curable compound. Hence, as the number of the secondary thiol groups increases, cross-linking density of the resin composition increases. This secures the affinity between the metal and the molding material. Therefore, the organic compound preferably includes two or more secondary thiol groups per molecule.

In the resin composition of the present invention, the curable compound preferably has two or more hydroxyl groups per molecule.

Since a metal surface from which an oxide layer is removed has a high affinity, it is considered that this metal surface has a high affinity with hydrophilic compound having a hydroxyl group. Hence, as the number of the hydroxyl groups in a molecule increases, bonding strength of the curable compound with the metal is enhanced. Additionally, cross-linking density of the curable compound with the organic compound having the secondary thiol group is improved, thereby enhancing bonding properties of the metal with the molding material.

In the resin composition of the present invention, the hydroxyl group is preferably a hydroxyl group derived from an acrylate. In case of curing a curable compound having at least one hydroxyl group per molecule, a response speed is faster in curing with use of ultraviolet ray (UV) than in curing with use of heating. Further, comparison of UV curing between an acrylic-resin-based compound and an epoxy-resin-based compound as the curable compound shows that the acrylic-resin-based compound cures more rapidly than the epoxy-resin-based compound.

Therefore, when the hydroxyl group is the hydroxyl group derived from an acrylate, that is, the curable compound is the acrylic-resin-based compound, a curing process to adhere the metal and the molding material with the resin composition of the present invention is performed more simply and rapidly.

Furthermore, in the resin composition of the present invention, the hydroxyl group is preferably a hydroxyl group derived from an epoxy ring or an oxetane ring.

Regarding adhesivity with a metal, generally an epoxy-resin-based compound or an oxetane (resin)-based compound has stronger adhesivity than the acrylic-resin-based compound. Therefore, with this structure, the adhesivity of the molding material with the metal is further enhanced.

Moreover, it is preferable to arrange the resin composition of the present invention such that the organic compound is in a range of 5% to 95% by weight and the curable compound is in a range of 95% to 5% by weight with respect to the resin composition, and the organic compound and the curable compound adds up to a total amount of 100% by weight.

The inventors found that an organic compound having at least one secondary thiol group per molecule had a high affinity for the molding material, and that bonding strength of the molding material and the metal cannot be enhanced only by the organic compound existing between the molding material and the metal. In order to enhance the bonding strength, the organic compound needs to coexist with the curable compound having at least one hydroxyl group per molecule.

Since the organic compound and the curable compound coexist in the resin composition, the structure allows effective use of the high affinity for the molding material of the organic compound and the high adhesiveness with the metal of the curable compound. Thus, the bonding strength between the molding material and the metal is enhanced.

A composite material of the present invention includes: the resin composition of the present invention; a metal; and a molding material, the metal being adhered to the molding material via the resin composition.

As described above, the resin composition of the present invention has a high affinity for both a metal and a molding material. Therefore, this structure allows strong adhesion of the metal and the molding material which has been difficult to attain until now. Accordingly, an electronic component can be provided in which a bonded section of the metal and the molding material is unlikely to peel off during use thereof, and may also be in use for ensuring airtightness of an electronic component that has a sealing structure.

A method for producing the composite material of the present invention includes: applying the resin composition of the present invention to a metal surface; curing the resin composition; and adhering the cured resin composition to a molding material.

With this structure, the resin composition has a high affinity for both a metal and a molding material.

Hence, it is possible to obtain a composite material in which the metal and the molding material are firmly adhered together by performing simple steps such as: (i) applying the resin composition on a metal surface by an appropriate method, (ii) curing the resin composition, and (iii) pressing or performing injection molding to the molding material on the cured resin composition.

Therefore, it is possible to obtain a composite material that has a thin adhesive thickness and in which a metal and a molding material are firmly adhered together, without carrying out complicated steps such as providing clearance between adherents that is generally required in applying adhesives. Such a composite material serves to reduce weight, thickness and size of an electronic component.

An electronic component of the present invention includes the composite material of the present invention. As described above, the composite material of the present invention is different from a conventional composite material in that the metal is firmly adhered to the molding material and a thickness of an applied resin composition is thin. Hence, with this structure, it is possible to provide an electronic component in which the bonded section between the metal and the molding material is unlikely to peel off during use thereof, and an electronic component having a sealing structure with high airtightness. Moreover, it is possible to provide a light, thin and small electronic component sufficient to satisfy the users' request.

For a fuller understanding of the nature and advantages of the invention, reference should be made to the ensuring detailed description taken in conjunction with the accompanying drawings.

### DESCRIPTION OF EMBODIMENTS

The following explains one embodiment of the present invention. However, the present invention is not limited to this.

1. Resin Composition

A resin composition according to the present invention includes (i) an organic compound having at least one secondary thiol group per molecule and (ii) a curable compound having at least one hydroxyl group per molecule, and is resin composition that remarkably enhances adhesive strength of a metal with a molding material.

The “an organic compound having at least one secondary thiol group per molecule” is a compound in which at least one thiol group is located in a carbon second to an end carbon of an organic compound, per molecule. The foregoing “end” can be either an end of a principal chain or an end of a side chain.

The organic compound is not particularly limited, and for example, 1,4-bis(3-mercaptobutyryloxy)butane represented by general formula 1; pentaerythritol tetrakis(3-mercaptobutyrate) represented by general formula 2; 1,3,5-tris(3-mercaptobutyloxyethyl)-1,3,5-triazine-2,4,6(1H,3H,5H)-trione represented by general formula 3; or dipentaerythritol hexakis(3-mercaptobutyrate) represented by general formula 4 may be used.

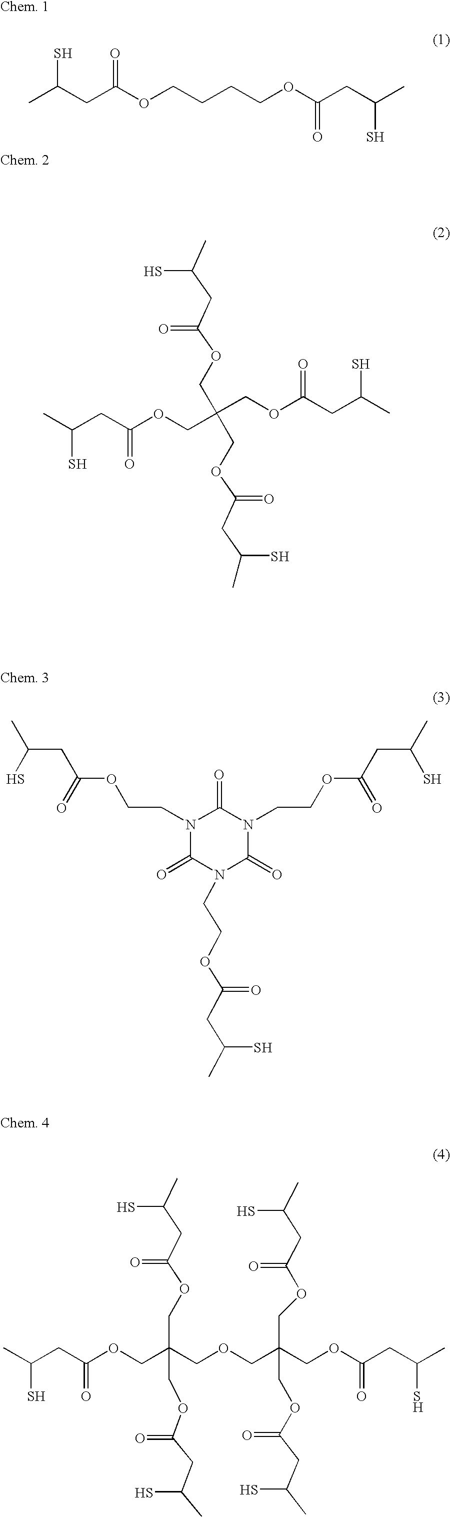

The compounds represented by formulae 1 to 4 each have thiol groups located in the carbon second to an end carbon. As compared to a primary thiol which is a compound in which a thiol group is located in a carbon at an end of the organic compound, the secondary thiol has a larger steric hindrance than that of the primary thiol and is not likely to be influenced by other compounds, as represented by formulae 1 to 4. That is to say, the primary thiol has a higher lability than that of the secondary thiol.

However, because the primary thiol has a higher lability, if the compound having the primary thiol group is substituted for the compound having the secondary thiol group in the resin composition of the present invention, the primary thiol group causes an addition reaction with the curable compound (for example, an acrylate or an epoxy compound) that has a hydroxyl group. This causes gelatinization of the resin composition. Therefore, the primary thiol is not suitable for bonding the metal to the molding material.

The resin composition of the present invention does not gelate as the foregoing because the resin composition includes the organic compound having at least one secondary thiol group per molecule. As described later in Examples and Comparative Examples, the inventors of the present invention found that the organic compound having at least one secondary thiol group per molecule has a high affinity for the molding material, further examined based on the finding what material should be mixed with the organic compound in order to attain a high affinity for both the metal and the molding material, and ultimately found that mixing the organic compound with the curable compound having at least one hydroxyl group per molecule caused an obtained resin composition to have a high affinity for both the metal and molding material.

A number of the secondary thiol groups included per molecule of the organic compound is preferably two or more, since such an amount further enhances the affinity between the organic compound and the molding compound. A maximum number of the secondary thiol groups is not particularly limited. However, since excessive curing contraction causes a decrease in adhesive strength, the number of the secondary thiol groups is preferably 6 or less. Furthermore, since the secondary thiol group can make a cross-linking structure with the curable compound having at least one hydroxyl group per molecule, the higher the number of the secondary thiol groups is, the more the cross-linking density with the curable compound is improved. This further ensures the affinity for the metal and the molding material.

Other functional groups included in the organic compound having at least one secondary thiol group per molecule are not particularly limited; for example, an alkyl group, a carbonyl group may be included. A molecular weight of the organic compound is not particularly limited.

In this specification, the curable compound having at least one hydroxyl group per molecule is a compound having at least one hydroxyl group in a molecule and which is capable of curing. Therefore, for example, a compound having an epoxy group (an epoxy compound), a compound having an oxetane ring (an oxetane compound) or a compound to which a hydroxyl group is bound as a side chain (for example, an acrylate) is used more preferably than acid and alcohol. In addition, curing may be performed by heat or light.

The curable compound having at least one hydroxyl group per molecule may be one which already includes a hydroxyl group at a monomer state. An acrylate is one example of such a compound. That is, the hydroxyl group may be a hydroxyl group derived from an acrylate. The acrylate is a typical UV curing monomer.

Moreover, the curable compound may include a hydroxyl group by ring-opening as a result of curing reaction. Examples of such a compound encompass an epoxy compound and a compound having an oxetane ring. That is, the hydroxyl group may be a hydroxyl group derived from the epoxy ring or a hydroxyl group derived from the oxetane ring. The epoxy compound is a typical thermosetting monomer.

The curable compound may include a hydroxyl group derived from an acrylate and a hydroxyl group derived from an epoxy ring or oxetane ring. Moreover, the curable compound may include all of the hydroxyl group derived from the acrylate, the hydroxyl group derived from the epoxy ring and the hydroxyl group derived from the oxetane ring. However, the curable compound preferably includes one of the hydroxyl group derived from the acrylate and the hydroxyl group derived from the epoxy ring or oxetane ring. For example, in UV curing, a reaction pattern differs between the acrylate, and the epoxy compound or the compound having the oxetane ring; the acrylate causes radical reaction, and the epoxy compound or the compound having the oxetane ring causes cationic reaction.

Thus, response speed in UV curing is totally different between the acrylate, and the epoxy compound or the compound having the oxetane ring. Accordingly, the curable compound having the hydroxyl group preferably includes one of the hydroxyl group derived from the acrylate and the hydroxyl group derived from the epoxy ring or oxetane ring.

Examples of the curable compound encompass, but are not limited to, compounds listed below. The following compounds may be used either singularly or in combination of two or more types thereof.

For example, the following curable compounds may be used: C₁₂ to C₁₃ mixed higher alcohol glycidylether (as a commercial item, for example, EPOLIGHT M-1230 manufactured by KYOEISHA CHEMICAL Co., Ltd.), ethyleneglycol diglycidylether (as a commercial item, for example, EPOLIGHT 40E manufactured by KYOEISHA CHEMICAL Co., Ltd.), ethyleneglycol diglycidylether (as a commercial item, for example, EPOLIGHT 100E manufactured by KYOEISHA CHEMICAL Co., Ltd.), polyethyleneglycol #200 diglycidylether (as a commercial item, for example, EPOLIGHT 200E manufactured by KYOEISHA CHEMICAL Co., Ltd.), polyethyleneglycol #400 diglycidylether (as a commercial item, for example, EPOLIGHT 400E manufactured by KYOEISHA CHEMICAL Co., Ltd.), propyleneglycol diglycidylether (as a commercial item, for example, EPOLIGHT 70P manufactured by KYOEISHA CHEMICAL Co., Ltd.), tripropyleneglycol diglycidylether (as a commercial item, for example, EPOLIGHT 200P manufactured by KYOEISHA CHEMICAL Co., Ltd.), polypropyleneglycol #400 diglycidylether (as a commercial item, for example, EPOLIGHT 400P manufactured by KYOEISHA CHEMICAL Co., Ltd.), neopentylglycol diglycidylether (as a commercial item, for example, EPOLIGHT 1500NP manufactured by KYOEISHA CHEMICAL Co., Ltd.), 1,6-hexanediol diglycidylether (as a commercial item, for example, EPOLIGHT 1600 manufactured by KYOEISHA CHEMICAL Co., Ltd.), glycerine diglycidylether (as a commercial item, for example, EPOLIGHT 80MF manufactured by KYOEISHA CHEMICAL Co., Ltd.), trimethylolpropane triglycidylether (as a commercial item, for example, EPOLIGHT 100MF manufactured by KYOEISHA CHEMICAL Co., Ltd.), hydrogenerated bisphenol-A diglycidylether (as a commercial item, for example, EPOLIGHT 4000 manufactured by KYOEISHA CHEMICAL Co., Ltd.), and bisphenol-A PO2-mol adduct diglycidylether (as a commercial item, for example, EPOLIGHT 3002 manufactured by KYOEISHA CHEMICAL Co., Ltd). Note that the curable compound is not limited to these examples.

Further examples of the curable compound encompass: 2-hydroxy-3 phenoxypropyl acrylate (as a commercial item, for example, EPOXY ESTER M-600A manufactured by KYOEISHA CHEMICAL Co., Ltd.), methacrylic acid adduct of the EPOLIGHT 40E (as a commercial item, for example, EPOXY ESTER 40EM manufactured by KYOEISHA CHEMICAL Co., Ltd.), acrylic acid adduct of the EPOLIGHT 70P (as a commercial item, for example, EPOXY ESTER 70PA manufactured by KYOEISHA CHEMICAL Co., Ltd.), acrylic acid adduct of the EPOLIGHT 200P (as a commercial item, for example, EPOXY ESTER 200PA manufactured by KYOEISHA CHEMICAL Co., Ltd.), acrylic acid adduct of the EPOLIGHT 80MF (as a commercial item, for example, EPOXY ESTER 80MFA manufactured by KYOEISHA CHEMICAL Co., Ltd.), methacrylic acid adduct of the EPOLIGHT 3002 (as a commercial item, for example, EPOXY ESTER 3002M manufactured by KYOEISHA CHEMICAL Co., Ltd.), acrylic acid adduct of the EPOLIGHT 3002 (as a commercial item, for example, EPOXY ESTER 3002A manufactured by KYOEISHA CHEMICAL Co., Ltd.), bisphenol-A diglycidylether methacrylic acid adduct (as a commercial item, for example, EPOXY ESTER 3000M manufactured by KYOEISHA CHEMICAL Co., Ltd.), and bisphenol-A diglycidylether acrylic acid adduct (as a commercial item, for example, EPOXY ESTER 3000A manufactured by KYOEISHA CHEMICAL Co., Ltd.). Note that the curable compound is not limited to these examples.

Moreover, further examples of the curable compound encompass 3-chloro-2-hydroxypropylmethacrylate (as a commercial item, for example, NK Ester topolene M manufactured by Shin-Nakamura Chemical Co., Ltd.) and bisphenol-A epoxy (as a commercial item, for example, AER-260 manufactured by Asahi Kasei Epoxy Corporation).

In addition, the curable compounds further may be 827, 828, 828EL, 834, 806, 806L, 807, 1001, 1002, 1003, 1055, 1004, 1004AF, 1007, 1009, 1010, 1003F, 1004F, 1005F, 1004FS, 1006FS, 1007FS, 4004P, 4005P, 4007P, 4010P and so on manufactured by Japan Epoxy Resins Co., Ltd. However, the curable compound is not limited to these examples.

Examples of an alicyclic epoxy encompass: 3,4-epoxycyclohexylmethyl-3′,4′-epoxycyclohexanecarboxylate (as a commercial item, for example, CEL2021 manufactured by DAICEL CHEMICAL INDUSTRIES, LTD.), 1,2:8,9 diepoxylimonen (as a commercial item, for example, CEL3000 manufactured by DAICEL CHEMICAL INDUSTRIES, LTD.), and 1,2-epoxy-4-(2-oxiranyl)cyclohexane adduct of 2,2-bis(hydroxymethyl)-1-butanol (as a commercial item, for example, EHPE manufactured by DAICEL CHEMICAL INDUSTRIES, LTD.). Note that the alicyclic epoxy is not limited to these examples.

Examples of the oxetane compound encompass 2-hydroxymethyloxetane, 3-methyl-3-oxetanemethanol, 3,3-dimethyloxetane, 3-methyl-3-methoxymethyloxetane (all manufactured by TOAGOSEI CO., LTD.), and 3-ethyl-3[(phenoxy) methyl]oxetane (manufactured by Kyoritsu Chemical & Co., Ltd.).

The curable compound preferably includes two or more hydroxyl groups per molecule from an aspect of improving cross-linking density of the resin composition of the present invention. Generally, the cross-linking density of the resin composition increases as the number of the hydroxyl groups per molecule increases, thereby obtaining a strong film. Thus, the maximum number of the hydroxyl groups is not particularly limited. Unless the number of hydroxyl groups becomes too much to the degree that causes the film to be hard and fragile, no practical problems particularly occur.

Functional groups other than the hydroxyl group included in the curable compound is not particularly limited, and for example, may include an alkyl group and a carbonyl group. In addition, a molecular weight of the curable compound is not particularly limited.

The resin composition of the present invention can be prepared by mixing an organic compound having at least one secondary thiol group per molecule and a curable compound having at least one hydroxyl group per molecule. A method of mixing is not particularly limited, and the compounds are preferably mixed by using a conventionally-known stirring device or the like.

It is preferable to include 5% to 95% by weight of the organic compound and 95% to 5% by weight of the curable compound in the resin composition, and more preferably includes 5% to 60% by weight of the organic compound and 95% to 40% by weight of the curable compound, in a case where the resin composition of the present invention includes a total of 100% by weight of the organic compound having at least one secondary thiol group per molecule and the curable compound having at least one hydroxyl group per molecule. It is essential to at least include both of the organic compound and the curable compound; an effect of the present invention cannot be achieved if only one of the two compounds is included in the resin composition.

Component(s) other than the organic compound and the curable compound are not particularly limited as long as the other component(s) do not disturb the effect of the present invention attained by the organic compound and the curable compound. For example, in order to accelerate a curing reaction, a photopolymerization initiating agent or thermal polymerization initiating agent may be included. An amount contained of the photopolymerization initiating agent or the thermal polymerization initiating agent is preferably 0.5 parts to 10 parts by weight with respect to the total amount of the compounds, where the total amount of the organic compound having at least one secondary thiol group per molecule and the curable compound having at least one hydroxyl group per molecule is 100% by weight.

The photopolymerization initiating agent is not particularly limited, and examples thereof encompass: 2-hydroxy-2-methyl-1-phenyl-propene-1-on, 2-methyl-1-[4-(methylthio)phenyl]-2-morpholinopropene-1-on, and 2,4,6-trimethylbenzoyl-diphenyl-phosphineoxide, triphenylsulfonyltriflate. These polymerization initiating agents can be used either singularly or in combination as appropriate.

The thermal polymerization initiating agent is not particularly limited, and examples thereof encompass: cumene hydroperoxide, t-butyl hydroperoxide, benzoyl peroxide, DBU, ethylenediamine, and N,N-dimethylbenzylamine. These polymerization initiating agents can be used either singularly or in combination as appropriate.

In order to compensate adhesiveness of the organic compound having at least one secondary thiol group per molecule and the curable compound having at least one hydroxyl group per molecule, a primer, silane coupling agent or the like may be used simultaneously. An amount added of the primer or the silane coupling agent is preferably 0.5 parts to 10 parts by weight with respect to a total amount of the compounds, where the total amount of the organic compound having at least one secondary thiol group per molecule and the curable compound having at least one hydroxyl group per molecule is 100% by weight.

Examples of the silane coupling agents that may be used encompass: 3-aminopropyl trimethoxysilane, 3-aminopropyl triethoxysilane, N-2(aminoethyl)3-aminopropylmethyl dimethoxysilane, N-2(aminoethyl)3-aminopropyl trimethoxysilane, N-2(aminoethyl)3-aminopropyl triethoxysilane, 3-glycidoxypropyl trimethoxysilane, 3-glycidoxypropylmethyl diethoxysilane, and 3-glycidoxypropyl triethoxysilane.

Furthermore, in order to adjust physical properties of the resin composition of the present invention, a reactive diluent may be used simultaneously. Adjustment of physical properties includes, for example, reducing viscosity of an epoxy resin, and adjustment of glass, transition temperature (TG) of a cured resin composition and adjustment of linear expansion coefficient. From an aspect of adhesiveness, an amount used of the reactive diluent is preferably 40% by weight or less and is most preferably 20% by weight or less with respect to 100% by weight of the resin composition of the present invention.

Moreover, in order to adjust the viscosity of the resin composition of the present invention, a solvent may be used other than the reactive diluent. The solvent may be used simultaneously with the reactive diluent. N-methylpyrrolidone, acetone, methanol, ethanol or the like can be used as the solvent, and the solvent is used by mixing with the resin composition of the present invention as appropriate. The solvent is preferably removed from the resin composition of the present invention at the end. For example, the solvent can be removed by heating or air drying the resin composition of the present invention after the resin composition is applied to a metal.

2. Composite Material and Method for Producing the Composite Material

A composite material of the present invention includes: a resin composition of the present invention; a metal; and a molding material, and the metal is adhered to the molding material via the resin composition.

Copper, phosphor bronze, tin, iron, aluminum, nickel or the like can be used as the metal, and the metal is not particularly limited. The curable compound having the hydroxyl group has a high affinity with the metal, and because of this, the resin composition of the present invention demonstrates adhesiveness with the metal.

For example, an acrylate, an epoxy compound, an oxetane compound or the like which is the curable compound having at least one hydroxyl group per molecule can adhere to various metals. This is because both a metal surface from which an oxide layer is removed and the curable compound having a hydroxyl group are hydrophilic, thereby having a high affinity.

Therefore, the metal is not particularly limited, and various metals may be used. For example, in the following example, phosphor bronze or phosphor bronze coated with tin is used as an example of the metal. However, the metal is not limited to this.

The present invention does not limit an applicable metal to aluminum, as in a technique disclosed in the foregoing Patent Literature 2. Hence, the resin composition of the present invention and the composite material of the present invention can be considered to be materials with high versatility.

A shape of the metal is not particularly limited. For example, a shape of the metal is selected as appropriate depending on its use, such as plate-shaped, film-shaped, spherical or the like, as long as the metal has a surface to which the resin composition of the present invention is applied.

The “molding material” is a thermoplastic resin or a thermosetting resin, and is not particularly limited to the examples. Examples of the molding material encompass: polyethylene, polypropylene, polystyrene, ABS resin, polyvinyl chloride, acrylonitrile/styrene resin, polymethyl methacrylate (PMMA), polyvinyl chloride, polyamide, polyacetal, polycarbonate (PC), modified polyphenylene ether, polybutylene terephthalate (PBT), polyethylene terephthalate (PET), polyethylene naphthalate (PEN), liquid crystalline polymer (LCP), polyphenylene sulfide (PPS), polyimide (PI), polyetherimide (PEI), polyarylate (PAR), polysulfone (PSF), polyethersulfone (PES), polyether ether ketone (PEEK), polytetrafluoroethylene (PTFE), phenol resin, urea resin, melamine resin, unsaturated polyester resin and epoxy resin.

The organic compound having at least one secondary thiol group per molecule has a high affinity for the molding material. Therefore, the molding material is not particularly limited, and the molding material to be bonded to the metal can be selected arbitrary.

In addition, the organic compound does not cause an addition reaction in response to a double bond of the curable compound having a hydroxyl group to gelate, as in the case of using a compound having a primary thiol group.

As described above, the inventors found that, when an organic compound having at least one secondary thiol group per molecule is mixed with a curable compound having at least one hydroxyl group per molecule, the resin composition having a high affinity for both a metal and molding material is obtained. The composite material of the present invention is provided based on this finding, and the composite material includes the resin composition of the present invention, a metal and a molding material. The metal is adhered to the molding material via the resin composition.

The composite material can be made by the following steps of: (i) applying the resin composition of the present invention to a metal surface, (ii) curing the resin composition and (iii) adhering the cured resin composition with the molding material.

In the step (i), a metal surface is processed by the resin composition of the present invention in such a manner that the resin composition is applied to the metal surface. How the resin composition is applied is not particularly limited. For example, methods that are usable encompass: a method of immersing the metal in a solution of the resin composition of the present invention; a method of applying a solution of the resin composition of the present invention to the metal surface by printing, or using a dispenser, brush, paddle, roller, caulk gun, air spray, nozzle spray, roll coater and so on; a method of adsorbing the metal to the resin composition electrochemically by having the metal to which the resin composition of the present invention is applied be a positive electrode and having a platinum plate and so on be a negative electrode.

The foregoing “apply” denotes making the metal surface in a wet state with the resin composition. In addition, the resin composition needs to be applied to at least a portion bonded with the molding material on the metal surface, and from an aspect of enhancing adhesiveness between the metal and the resin composition, it is preferable that the resin composition is evenly applied to at least the foregoing portion.

A shape of the metal surface is not particularly limited, and may be either an even, smooth surface or a bumpy surface. The resin composition of the present invention has a high affinity for a metal and a molding material; since the resin composition does not require attainment of an anchor effect in bonding the metal to the molding material, the metal can be firmly bonded to the molding material even if the metal surface is even and smooth.

In addition, the solution may include the foregoing polymerization initiating agent, reactive diluent, solvent, primer, silane coupling agent and so on. Moreover, in order to improve adhesive property it is preferable to wash the metal surface to remove an oxide film from the metal surface before the resin composition is applied to the metal surface. How to wash the metal surface is not particularly limited, and usable methods encompass: a method of washing the metal surface in basic, neutral or acid liquid and a method of radiating energy such as plasma to the metal surface.

As the basic liquid, for example, hydroxides of alkali hydroxide metals such as sodium metasilicate, sodium hydroxide and potassium hydroxide, and aqueous solutions of soda ash, ammonia or the like may be used. Concentration of the solution is not particularly limited, and a concentration of 0.1% or more is sufficient. As the neutral liquid, for example, water, a surface active agent or the like may be used. As the acid liquid, for example, dilute nitric acid, dilute hydrochloric acid, hydrofluoric acid and so on may be used. Concentration of the liquid is not particularly limited, and a concentration of 0.1% or more is sufficient.

The step (ii) is a process for curing the resin composition, and the resin composition can be cured by use of the foregoing photopolymerization initiating agent, thermal polymerization initiating agent, or use of activation energy rays such as radial ray, electron ray, ultraviolet ray and electromagnetic ray.

In case of using a photopolymerization initiating agent, the resin composition can be cured by irradiating a side to which the resin composition is applied with light (for example, ultraviolet ray) having a wavelength that allows the photopolymerization initiating agent absorbing the light to generate radical. It is preferable that intensity of the light is in a range of 0.5 to 300 mW/cm² and a total amount of the light is at least 1000 mJ/cm².

Furthermore, in case of using a thermal polymerization initiating agent, the metal to which the resin composition is applied is heated at a temperature in which the thermal polymerization initiating agent decomposes to generate radical, to cure the resin composition. For example, the metal is preferably heated at a temperature of 80° C. to 170° C. for 1 to 3 or more hours.

Thickness of a film of the cured resin composition is not particularly limited. However, in view of reducing thickness of an electronic component, the thickness is preferably 300 μm or less.

As described above, conventionally, in order to bond a molding material to a metal material, the molding material and the metal material are formed individually, an adhesive is applied to the molding material and the metal material, and the adhesive is cured by energy such as heat or UV. However, in the case of bonding the metal to the molding material, it is necessary to carry out a complicated process in that the adhesive is applied to the molding material and the metal material while ensuring a clearance between the metal and the molding material. Moreover, a thickness of the adhesive reaches about 600 μm.

The present invention does not require such a complicated process and also is capable of producing a thin film. Thus, the present invention significantly contributes to reduction of thickness of an electronic component. For example, in Example 3 later described, a thin film having a thickness of just 50 μm is attained as a cured film.

In the step (iii), the cured resin composition is applied to the molding material. How the resin composition and the molding material are adhered is not particularly limited, and for example, a method of adhering a section in which the resin composition is applied on the metal surface to a section on the molding material which is to be bonded to the resin composition and then pressing the adhered sections together, or an injection molding process may be used. Thereby, the metal is adhered to the molding material via the resin composition. Whether adhesion is securely performed or not is determined by an adhesiveness evaluation method according to JIS K5600-5-6, as described later in the examples.

A pressure is not particularly limited for pressing the molding material and the metal material together, however is preferably in a range of 10 N to 50 N. Moreover, a temperature of the resin composition and the molding material at the time of pressing is not particularly limited, however the temperature is preferably a temperature at which the molding material melts. In addition, a pressed time may be changed as appropriate according to the pressure and the temperature. The pressing can be performed by a conventionally-known pressing machine, roller or the like.

As described above, the step (iii) may be performed by the injection molding process. A condition of the injection molding is not particularly limited, and the injection molding may be carried out by following a conventionally-known method. For example, the molding material that is heated to a temperature whereby softening the molding material may be pressed into a mold made of the metal by applying injection pressure (for example, in a range of 10 N to 50 N); the molding material then being filled in the mold and thereafter formed.

As described above, the resin composition of the present invention has both a high affinity for the molding material and the metal, which high affinity for the molding material is a property of the organic compound having at least one secondary thiol group per molecule and which high affinity for the metal is a property of the curable compound having at least one hydroxyl group per molecule. Hence, by using this resin composition, it is possible to obtain a composite material in which the metal is bonded firmly to the molding material.

As illustrated in Comparative Example 4 later described, a triazine thiol compound disclosed in Patent Literature 1 does not demonstrate sufficient adhesive strength on an interface of a metal and a molding material. The present invention is accomplished as a result of finding that the organic compound has a high affinity for the molding material, and further carrying out diligent study of what material to mix with the organic material in order to obtain a resin composition suitable for forming a composite material.

A technique to bond a metal to a molding material and integrate the metal and the molding material has been requested from broad fields, such as automobile, electric home appliance, and industrial equipment fields. Therefore, an electronic component including the composite material using the resin composition of the present invention is an extremely useful electronic component having a high airtightness at an interface between the metal and the molding material and having a high sealing property. Examples of an electronic component to which the composite material of the present invention is applicable encompass various electronic components such as a semiconductor, a liquid crystal display panel, high frequency electric components and electric components used for automobiles.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### Example

As described below, adhesiveness of a metal substrate with a molding material was measured by an adhesiveness evaluation method according to JIS K5600-5-6.

[Adhesiveness Evaluation Method]

On a surface of a molding material which was formed on a metal surface, cuts were made in a gridlike fashion having intervals of 1 mm by using a cutter knife. Cellophane tape was applied to the surface of the molding material, and thereafter the tape was peeled off.

Evaluation was made for 25 grids; the number of grids which remained on the metal was measured after the tape was peeled off.

### Example 1

A phosphor bronze substrate (C5191R manufactured by Harada Metal Industry Co., Ltd.) was washed by supersonic cleaning with 5% sodium metasilicate aqueous solution for 10 minutes, thereafter the substrate was rinsed in water and dried. Next, a resin composition (I) stirred and prepared by adding 5 parts by weight of a thermal polymerization initiating agent CP-77 (2-butenyltetramethylenesulfonium hexafluoroantimonate; manufactured by ADEKA CORPORATION) to 50 parts by weight of hydrogenerated bisphenol diglycidyl ether (commercial name: EPOLIGHT 4000 manufactured by KYOEISHA CHEMICAL Co., Ltd.) and 50 parts by weight of 1,4-bis(3-mercaptobutyryloxy)butane (commercial name: BD 1; manufactured by Showa Denko K.K.), was applied to the phosphor bronze substrate with a dispenser.

The phosphor bronze substrate to which the resin composition (I) was applied was left to stand at a temperature of 150° C. for 1 hour, to cure the resin composition (I). A pellet made of polybutylene terephthalate (hereinafter referred to as PBT) was interleaved between the substrate and an unprocessed phosphor bronze substrate, and this was pressed at a temperature of 240° C. for 30 seconds by using a pressing machine (a desktop hot press machine: G-12; manufactured by Orihara Manufacturing Co., Ltd.). The “150° C.” is a temperature inside a hot-air drying chamber, and the “240° C.” is a temperature of top and bottom parts of the hot press machine. After the pressed sample was taken out from the pressing machine, the unprocessed phosphor bronze substrate was removed, thereby obtaining a sample 1 having PBT provided on the phosphor bronze substrate. The adhesiveness test was carried out to the sample 1, and as a result, it was observed that all 25 grids remained.

### Example 2

A resin composition (II) was prepared under the same conditions as in Example 1 except that 70 parts by weight of EPOXY ESTER 80MFA (manufactured by KYOEISHA CHEMICAL Co., Ltd.) was used in substitution for the hydrogenerated bisphenol diglycidyl ether used in Example 1, 30 parts by weight of 1,3,5-tris(3-mercaptobutyloxyethyl)-1,3,5-tiriazine-2,4,6(1H,3H,5H)-trione (commercial name: IS1 manufactured by SHOWA DENKO K.K.) was used in substitution for the 1,4-bis(3-mercaptobutyryloxy)butane, and a photopolymerization initiating agent: IRGACURE 907 (2-methyl-1[4-(methylthio)phenyl]-2-morpholinopropane-1-one (manufactured by Ciba Speciality Chemicals Co., Ltd.) was used in substitution for the CP-77.

The resin composition (II) was applied to the phosphor bronze substrate with a dispenser, and 3600 mJ/cm² of ultraviolet ray was radiated on the resin composition (II) by use of a black light (Fiber Tank 750, manufactured by Takeden Corporation) to cure the resin composition (II). A pellet of PBT was interleaved between the substrate and an unprocessed phosphor bronze substrate, and this was pressed at a temperature of 240° C. for 30 seconds by the pressing machine. After the pressed sample was taken out from the pressing machine, the unprocessed phosphor bronze substrate was removed, thereby obtaining a sample 2 having PBT provided on the phosphor bronze substrate. The adhesiveness test was carried out to the sample 2. As a result, it was observed that all 25 grids remained.

### Example 3

A resin composition (III) was obtained by adding, to 50 parts by weight of hydrogenerated bisphenol diglycidyl ether (commercial name: EPOLIGHT 4000; manufactured KYOEISHA CHEMICAL Co., Ltd.) and 50 parts by weight of 1,4-bis(3-mercaptobutyryloxy)butane (commercial name: BD1; manufactured by Showa Denko K.K.), 5 parts by weight of ADEKA OPTOMER SP-170 which is a photopolymerization initiating agent (triarylsulfonium hexafluoroantimonate, manufactured by ADEKA CORPORATION) in substitution for the CP-77 used in Example 1, and 100 parts by weight of N-methylpyrrolidone as a solvent.

A substrate in which tin is coated on a surface of phosphor bronze was washed by supersonic cleaning for 10 minutes with 5% sodium metasilicate aqueous solution, thereafter the substrate was rinsed in water and dried. The resin composition (III) was applied to the substrate with a dispenser and the substrate was left to stand at a temperature of 150° C. for 15 minutes, to remove the solvent. Then, 3600 mJ/cm² of ultraviolet ray was radiated on the substrate by the black light to cure the resin composition (III). This obtained a 50 μm thin film as a cured film.

Subsequently, a pellet made of a liquid crystalline polymer (E6008; LCP, manufactured by Sumitomo Chemical Co., Ltd.) as a molding material was interleaved between the cured substrate and an unprocessed phosphor bronze substrate, and this was pressed at a temperature of 330° C. for 30 seconds by the pressing machine. After the pressed sample was taken out from the pressing machine, the unprocessed phosphor bronze substrate was removed, thereby obtaining a sample 3 having the LCP provided on the phosphor bronze substrate coated by tin. The adhesiveness test was carried out to the sample 3. As a result, it was observed that all 25 grids remained.

The LCP (Liquid Crystalline Polymer) is a polymer in which its molecular chain is lined up in a substantially regular manner even if a resin melts at a high temperature, dissolves in a solvent and is made into a flowing state.

### Comparative Example 1

A resin composition (IV) was prepared under the same conditions as in Example 1, except that 100 parts by weight of the hydrogenerated bisphenol diglycidyl ether used in Example 1 was used in substitution for 50 parts by weight thereof, and that the 1,4-bis(3-mercaptobutyryloxy)butane used in Example 1 was not used. The resin composition (IV) was applied to a phosphor bronze substrate, was cured in the same conditions as in Example 1 and was pressed by the pressing machine under the same conditions as that in Example 1 to prepare a sample 4. The adhesiveness test was carried out to the sample 4, and as a result, it was observed that all 25 grids were peeled off on an interface between PBT and the resin composition (IV).

### Comparative Example 2

A resin composition (V) was prepared under the same conditions as in Example 1, except that 100 parts by weight of the 1,4-bis(3-mercaptobutyryloxy)butane was used in substitution for 50 parts by weight thereof, and that the hydrogenerated bisphenol diglycidyl ether used in Example 1 was not used. The resin composition (V) was applied to a phosphor bronze substrate, was cured in the same conditions as in Example 1 and was pressed by the pressing machine under the same conditions as in Example 1 to prepare a sample 5. The adhesiveness test was carried out to the sample 5, and as a result, it was observed that all 25 grids were peeled off on an interface between the substrate and the resin composition (V).

### Comparative Example 3

A resin composition (VI) was prepared under the same conditions as in Example 2, except that monoethanolamine thioglycolate was used in substitution for 1,3,5-tris(3-mercaptobutyloxyethyl)-1,3,5-triazine-2,4,6(1H,3H,5H)-trione used in Example 2. This resin composition (VI) thickened with time, and as a result, gelatinized. Thus, the resin composition (VI) could not be evaluated in its adhesiveness.

### Comparative Example 4

A resin composition (VII) was prepared under the same conditions as in Example 2, except that 2-di-n-butylamino-4,6-mercapto-s-triazine (ZISNET-DB manufactured by SANKYO Chemical Co., Ltd.) was used in substitution for 1,3,5-tris(3-mercaptobutyloxyethyl)-1,3,5-tiriazine-2,4,6(1H,3H,5H)-trione used in Example 2. The resin composition (VII) was applied to a phosphor bronze substrate, was cured under the same conditions as in Example 1 and was pressed by the pressing machine in the same conditions as in Example 1, to prepare a sample 6. The adhesiveness test was carried out to the sample 6, and as a result, it was observed that all 25 grids were peeled off on an interface between the substrate and the resin composition (VII).

Thus, a resin composition of the present invention includes an organic compound having at least one secondary thiol group per molecule and a curable compound having at least one hydroxyl group per molecule. Consequently, adhesive strength between any metal and any molding material is sufficiently attainable.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A resin composition of the present invention includes an organic compound having at least one secondary thiol group per molecule and a curable compound having at least one hydroxyl group per molecule. Thus, the resin composition can firmly bond to both a molding material and a metal. This allows providing a composite material in which a molding material is firmly bonded to a metal. Hence, the resin composition is capable of providing an electronic component having a high airtightness on an interface between the metal and the molding material and having a high sealing property, and the resin composition is extremely useful.

1. A resin composition comprising:
an organic compound having at least one secondary thiol group per molecule; and
a curable compound having at least one hydroxyl group per molecule.

2. The resin composition as set forth in claim 1, wherein:
the organic compound has two or more secondary thiol groups per molecule.

3. The resin composition as set forth in claim 1, wherein:
the curable compound has two or more hydroxyl groups per molecule.

4. The resin composition as set forth in claim 1, wherein:
the hydroxyl group is a hydroxyl group derived from an acrylate.

5. The resin composition as set forth in claim 1, wherein:
the hydroxyl group is a hydroxyl group derived from an epoxy ring or an oxetane ring.

6. The resin composition as set forth in claim 1, wherein:
the organic compound is in a range of 5% to 95% by weight and the curable compound is in a range of 95% to 5% by weight with respect to the resin composition, the organic compound and the curable compound adding up to a total amount of 100% by weight.

7. A composite material comprising:
a resin composition as set forth in claim 1;
a metal; and
a molding material,
the metal being adhered to the molding material via the resin composition.

8. A method for producing a composite material as set forth in claim 7, comprising the steps of:
applying a resin composition as set forth in claim 1 to a metal surface,
curing the resin composition, and
adhering the cured resin composition to a molding material.

9. An electronic component comprising:
a composite material as set forth in claim 7.
